(19) United States
(12) Patent Application Publication
(10) Pub. No.: US 2011/0005193 A1
(43) Pub. Date: Jan. 13, 2011

(54) Method and apparatus for simplified thrust chamber configurations

(76) Inventors: Thomas Clayton Pavia, Mojave, CA (US); James Robert Grote, Mojave, CA (US)

Correspondence Address: THOMAS CLAYTON PAVIA, P.O. BOX 998, MOJAVE, CA, 93502, US

(21) Appl. No.: 12/803,836

(22) Filed: Jul. 6, 2010

Related U.S. Application Data
(60) Provisional application No. 61/270,415, filed on Jul. 7, 2009.

(51) Int. Cl. F02K 9/64

(52) U.S. Cl. 60/206

(57) ABSTRACT

The invention of this disclosure is methods and apparatuses improving the ease of fabrication and delivered specific impulse performance of simplified rocket engine thrust chambers. Included are a method and apparatus for a pool-boiling cooling system rocket thrust chamber. This cooling system utilizes a convective coolant flowing in a continuous or semi-continuous coolant loop. In addition the convective coolant itself is cooled in a pool-boiling heat exchanger by the evaporation of a propellant that functions as a boiling coolant. The invention also includes a method and apparatus for a shortened, simplified, conical expansion nozzle for a rocket thrust chamber that can operate with reduced specific impulse losses due to nozzle configuration and the use of film coolant in the thrust chamber.

### CROSS-REFERENCE TO RELATED APPLICATIONS

None.

### FEDERALLY SPONSORED RESEARCH

None.

### SEQUENCE LISTING

None.

### PRIORITY

This application claims the benefit and priority of U.S. Provisional Patent Application Ser. No. 61/270,415 filed 07 Jul. 2009 under 35 U.S.C. 119(e) entitled ‘Thrust Chamber Cooling System Utilizing a Pool-Boiling Heat Exchanger’ and U.S. Provisional Patent Application Ser. No. 61/208,174 filed 20 Feb. 2009 under 35 U.S.C. 119(e) entitled ‘Greater Isp Performance By Increasing Nozzle Afterburning’.

### FIELD

This disclosure relates generally to propulsion systems, and more particularly to rocket engine thrust chambers and rocket thrust chamber cooling systems and rocket thrust chamber configurations.

### BACKGROUND

### Conventional Rocket Engine Thrust Chamber Cooling

In a conventional liquid bi-propellant rocket engine 124, (see Assy 124, FIG. 1) a main propellant injector 140 sprays liquid main propellants 200, 210 into a combustion chamber 160, where the main propellants are burned. The burned propellants create high temperature core combustion gases 158 (or simply called core gases 158, see FIG. 3) that expand in an expansion nozzle 180 where the gases increase in velocity and produce the majority of the rocket engine's thrust although some of the thrust can be produced by various coolants injected into the thrust chamber 120. A thrust chamber 120 (FIG. 1) is comprised of both the combustion chamber 160 and the expansion nozzle 180. The structure of the specific thrust chamber in FIG. 1 is comprised of the inner shell 104, outer shell 106, and the nozzle shell 164, the nozzle shell 164 in FIG. 1 being a single sheet metal shell structure.

Most conventional liquid propellant rocket engines are liquid bi-propellant rocket engines where there are two main thrust producing propellants comprising of a fuel 200 and an oxidizer 210 that are burned in the combustion chamber 160 to produce the majority of the rocket engine's thrust.

For many conventional thrust chambers 120 cooling is accomplished by one of the propellants (usually the fuel 200) that flows through coolant tubes or coolant channels in the structure of the thrust chamber 120. The relatively cool propellant flowing in the coolant tubes or channels cools the thrust chamber structure and prevents the thrust chamber structure from failing or melting. This type of conventional fluid-cooled rocket engine is called a regenerative cooled engine because one of the engine's main propellants is used to cool the thrust chamber 120 before it is burned in the combustion chamber 160. Examples of regenerative cooled engines are the Space Shuttle's SSME engine and the Apollo program's F-1 and engines.

The thrust chambers 120 of conventional regenerative cooled rocket engines can include large numbers of individual coolant tubes or channels, perhaps dozens to as high as one thousand and above. When manufacturing with coolant tubes the coolant tubes are brazed or welded together side-by-side like asparagus whereas cooling channels are often fabricated from large, thick metal shells that require extensive machining, custom tooling, and custom processes to fabricate the fluid cooling channels in the thrust chamber 120. These types of coolant tubes and coolant channels for regenerative cooled thrust chambers 120 are produced by a small number (perhaps several) of very specialized, high-overhead, expensive fabricators. The cooling system of the thrust chamber 120 is very often a large part of the procurement expense of a rocket engine 124 and often requires a long lead-time to manufacture.

### Background

### Conventional Rocket Engine Expansion Nozzle Shaple

Conventional rocket engines usually have a ‘bell’ or DeLaval type expansion nozzle 180 that is based on a parabolic or semi-parabolic cross-section shape and is more complicated and expensive to make than a simpler cone-shaped expansion nozzle 180. This invention makes possible the use of simplified and shortened cone-shaped or ‘conical’ nozzles by reducing the rocket engine performance losses (called Isp losses) associated with short, conical nozzles and with film cooling of the thrust chamber 120. Film coolant 128, 150 is a fluid that is often sprayed or flowed on the thrust chamber 120 interior wall, called the hot-wall 122 (see FIG. 3), to help cool the thrust chamber 120 and results in specific impulse or Isp. This invention can reduce the Isp losses associated with these causes. The flowrate of film cooling fluids to a rocket engine are typically, but not limited to, 1% to 10% of the total fluid flowrate to the rocket engine 124 with 3% being typical. The total fluid flowrate to the rocket engine 124 is comprised of the main propellants and any coolants, including film coolants, flowing to and expended by the rocket engine. For rocket engines utilizing pumps the pumping system or gas generating mechanism driving the pumps are considered as part of the rocket engine..

### FIGURES

FIG. 1 shows the components of a conventional pressure-fed rocket engine 124 including a main propellant injector 140 and a thrust chamber 120 that is comprised of a combustion chamber 160 and an expansion nozzle 180 and constructed with simple sheet metal construction of an inner, outer, and nozzle shells 104, 106, 164. The main propellant injector 140 in FIG. 1 happens to be a pintle main propellant injector 140. The coolant feed tank 112 is pressurized by an optional tank pressure inlet 232.

FIG. 2 shows a thrust chamber pool-boiling cooling system 220 with a coolant loop 116. The main propellant injector 140 in FIG. 1 happens to be a flat-face main propellant injector 140.

FIG. 3 shows a rocket engine 124 with a simplified shortened conical expansion nozzle 180 with a diverging half-angle of approximately 27.5 degrees. This rocket engine assembly 246 is film cooled 150 but the expansion nozzle 180 is designed for increase afterburning of the fuel-rich film coolant with oxidizer-rich combustion core gases 158.

FIG. 4 shows simplified, shortened conical expansion nozzle assembly 242 that creates increased afterburning between fuel-rich film coolant 128 and the oxidizer-rich combustion core gases 158 by the use of a step 244 fabricated in the hot-wall 122 of the expansion nozzle that creates increased turbulence 166 in the film coolant boundary layer 162 and thus increases combustion between the fuel-rich film coolant 128 with oxidizer-rich combustion core gases 158.

### SUMMARY OF METHOD

### Pool-Boiling Cooling

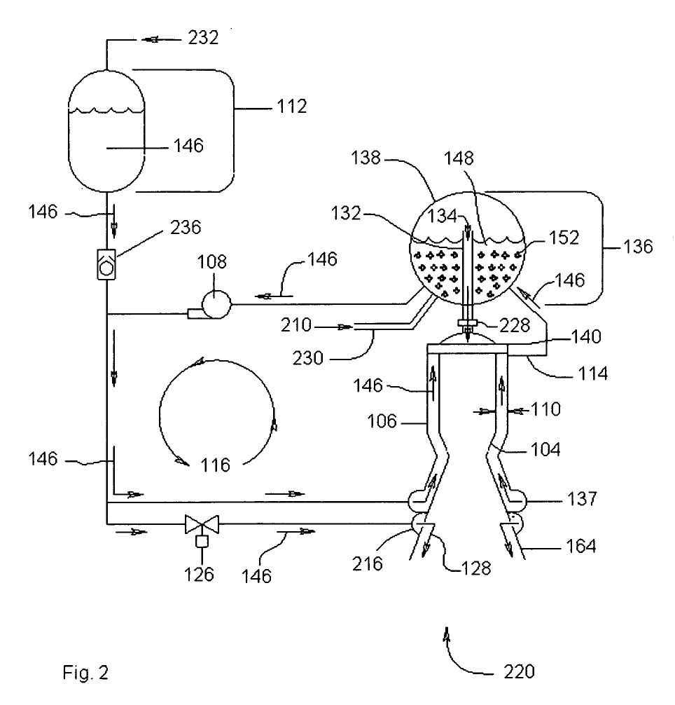

The method of this invention includes a rocket engine thrust chamber 120 pool-boiling cooling system 220, FIG. 2, that utilizes a convective coolant 146, usually but not always a liquid coolant, a pool-boiling heat exchanger 136, and a boiling coolant 148; the convective coolant 146 being circulated in a closed or partially closed flow path called a coolant loop 116 (see FIG. 2). Although it can be used with any type or size of rocket engine, rocket thruster, rocket propulsion device, jet engine, or jet engine propulsion device, or utilize any fluids or coolants, a pool-boiling cooling system 220 for a liquid bi-propellant rocket engine is described in the following sections. The cooling system of this method is not limited to the features of the specific rocket engines, thrust chambers, heat exchangers, propellants, or coolants described in the apparatus sections of this disclosure. The rocket engine shown if FIG. 2 will also be known as the combustion device of the pool-boiling cooling system 220.

Briefly stated, the convective coolant 146 in the coolant loop 116 at least partially removes the heat from the thrust chamber 120 that comes form the combustion of the rocket propellants. The heat in the convective coolant 146 absorbed in the thrust chamber 120 is then at least partially transferred to a boiling coolant 148 in a pool-boiling heat exchanger 136. The now cooled convective coolant 146 is circulated back to the thrust chamber 120 to absorb more of the thrust chamber's heat.

The advantage of a pool-boiling cooling system 220 is that it makes possible the use of a thrust chamber 120 utilizing simplified and low cost construction techniques such as but not limited to welded sheet metal construction and dual shell thrust chamber 120 construction as is shown in FIG. 2 consisting of an inner and outer shell 104, 106 with a convective coolant 146 flow gap 110 in between the shells. This configuration allows for a convective coolant 146 flow system that can vary in pressure depending on the specific pool-boiling cooling system 220 size or configuration. During rocket engine operation the fluid pressure in the gap 110 can be set low enough so that the inner or outer shells 104, 106 will not buckle or fail during rocket engine operation. The gap 110 pressure can be low enough where the structure of the shells or any attachment between the shells can be kept to a minimum thus preserving the simplicity of using spun and welded sheet metal thrust chamber construction. The gap 110 pressure can be, but not limited to, as low as 10 psia to 100 psia. Other gap 110 pressures are possible.

### Summary of Method

### Simplified Expansion Nozzles with Reduced Specific Impulse Losses due to Film Cooling and Nozzle Contour

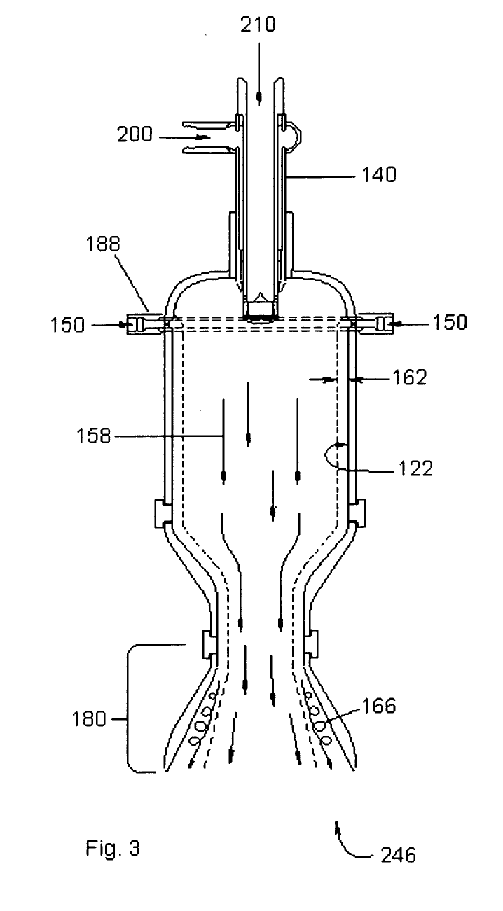

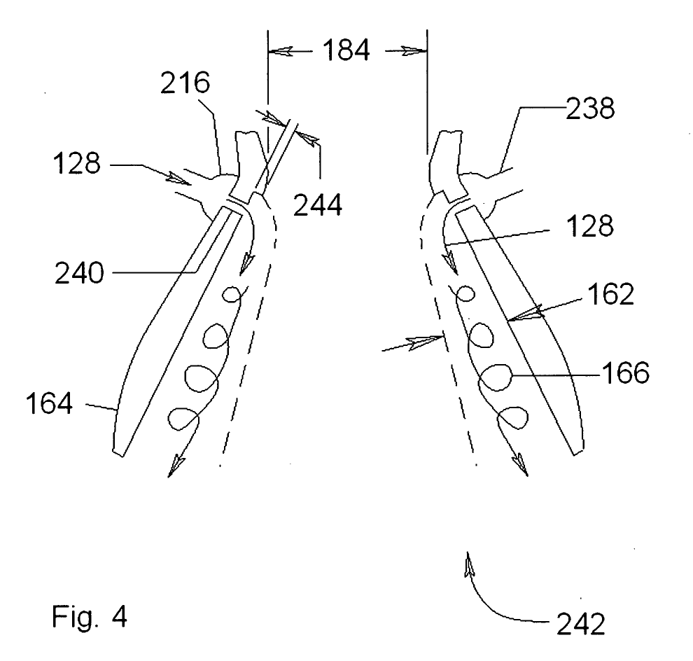

The method of this invention also includes the use of a shortened, cone-shaped or conical expansion nozzle 160, FIGS. 3, 4 as opposed to a parabolic Delaval expansion nozzle 160. The shortened conical expansion nozzle 160 is used in conjunction with oxidizer-rich core gases 158 and a thrust chamber film coolant 150 (also simply called film coolant 150) or a nozzle film coolant 128 or both. A film coolant is a fluid that is injected anywhere onto the interior wall 122 of the thrust chamber 120 for the purposes of at least partially cooling at least a portion of the thrust chamber 120. For illustration purposes for this method the rocket engine's core gases 158 will be oxidizer-rich used in conjunction with a film coolant 150 that is a fuel. A fuel film coolant is a film cooling fluid that is a combustible fluid that will burn with an oxidizer or oxidizer-rich fluids. Core gases 158 are the gases in the thrust chamber 120 that result from the combustion of the main propellants in the thrust chamber 120.

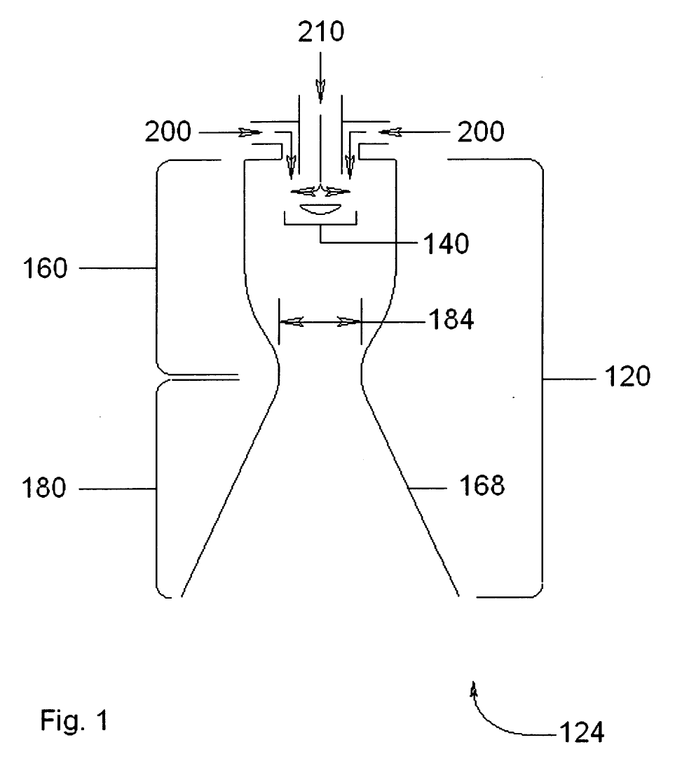

The advantage of a shortened conical expansion nozzle 160 utilized with a combustible fuel film coolant 150 and oxidizer-rich core combustion gases 158 is that it makes possible the use of a simpler, cheaper to produce expansion nozzle shape, a cone versus a parabola, with reduced rocket engine performance losses, called Isp losses or specific impulse losses, usually associated with cone-shaped expansion nozzles 160 as opposed to bell, parabola, or DeLaval nozzles or nozzles that have a wider than optimal diverging half-angle 168, FIG. 1, and are thus shorter nozzles than optimal. It also reduces the Isp losses due to the use of any type of film coolant 150, 128.

These reduced Isp losses can occur because simpler conical nozzles which are made to a shorter length cause an increase in turbulence in the boundary layer of the expansion nozzle 180. This increase in turbulence increases the mixing of the fuel film coolant 150, 128 (FIGS. 3, 4) with the oxidizer-rich core combustion gases 158 (FIG. 3) and thus causes an increase in afterburning of the film coolant in the expansion nozzle 180 which reduces the specific impulse losses due to the use of film coolant in the thrust chamber 120 and the simplified, shortened nozzle configuration. Nozzle afterburning is when a fuel film coolant or other fuel-rich gases combust in the expansion nozzle 180 with oxidizer-rich core gases 158.

### Use of the Method

A rocket engine, rocket thruster, or rocket propulsion device can use the pool-boiling heat exchanger cooling system 220 and the shortened conical expansion nozzle 160 either together or singularly (using one but not the other) as helpful.

### Method Implementation Sequence

### Pool-boiling Cooling System

1.) A pool-boiling cooling system 220 whereas;

2.) a quantity of convective coolant 146 flows through at least a portion of the structure of a thrust chamber 120 cooling at least a portion of the thrust chamber 120;

3.) the quantity of convective coolant 146 then flows through the heat exchanger flow passages 152 of a pool-boiling heat exchanger 136 heating a boiling coolant 148 and cooling the convective coolant 146;

4.) at least a portion of the heated boiling coolant 148 flows out of the pool-boiling heat exchanger 136 and is combusted in the thrust chamber 120 as a propellant;

5.) the quantity of convective coolant 146 then flows back to the thrust chamber 120 in a coolant loop 116 to cool at least a portion of the thrust chamber 120 with the sequence repeating at least once.

### Method Implementation Sequence

### Simplified Expansion Nozzle with Reduced Isp Losses

1.) A combustion device that has a oxidizer-rich core combustion gases 158 and is at least partially cooled with a fuel-rich film coolant; and

2.) the combustion device has an expansion nozzle 180 that has a diverging half-angle 168 that creates turbulence 166 in the film coolant boundary layer 162; and

3.) the turbulence 166 caused increased mixing and combustion between the fuel film coolant and the core combustion gases 158 in the expansion nozzle 180 reducing the performance losses of the combustion device.

### Apparatus of Method

### Example Rocket Engine with Pool-Boiling Cooling of the Thrust Chamber

The pool-boiling cooling system 220 presented in FIG. 2 is shown as being used with only one of many different possible rocket engines, rocket thrust chambers 120, or rocket systems that can utilize this invention. The example rocket engine of FIG. 2 is a pressure-fed rocket engine 124 utilizing liquid oxygen and jet fuel as main propellants with a combustion chamber 160 internal operating pressure of 300 psia. The sea level engine thrust is a nominal of 250,000 lbs, the nozzle area ratio is 6.3, and the main propellant injector 140 is what is known in the rocket industry as a flat-face injector. The structure of the thrust chamber 120 is composed of inner, outer, and nozzle shells 104, 106, 164 with a gap 110 between the inner and outer shells. It is not shown in FIG. 2, but the thrust chamber 120 structure is partially cooled by a fuel film coolant 150 injected along the hot-wall 122 of the combustion chamber 160 just below the main propellant injector 140 in the manner shown in FIG. 3. The convective coolant 146 is comprised of 60% ethyl alcohol and 40% water by volume, and a nozzle film coolant 128 is injected along the hot-wall 122 of the expansion nozzle 180 below the thrust chamber throat 184. After cooling at least a portion of the thrust chamber 120 the convective coolant 146 flows into a pool-boiling heat exchanger 136 where the convective coolant 146 is cooled by the boiling coolant 148 which is the main oxidizer 210, liquid oxygen (FIG. 2). The heat transfer of the convective coolant 146 is achieved by the convective coolant 146 being pumped (by a recirculation pump 108) in a continuous or semi-continuous coolant loop 116 between the thrust chamber 120 and the pool-boiling heat exchanger 136.

The rocket engine 124 of this disclosure is defined as the combination of the thrust chamber 120 and the main propellant injector 140. A pressure-fed rocket engine is a rocket engine that has its main propellants pushed into it mainly by the internal operating pressure of the tanks or containers holding the main propellants. The main propellants are the fluids that are burned or combusted in the combustion chamber 140 that produce the majority of thrust of the rocket engine 124.

In the example cooling system of FIG. 2, as the boiling coolant 148 that cools the convective coolant 146, liquid oxygen evaporates in the pool-boiling heat exchanger 136 to become the evaporated coolant 134. A total of about 10% of the total liquid oxygen flowrate to the rocket engine 124 is thus evaporated in order to cool the convective coolant 146. The resulting evaporated coolant 134, gaseous oxygen (Gox), is fed to the main propellant injector 140 through a gas-tube 132 where it is injected into the combustion chamber 160 and combusted in addition to the fuel 200 and non-evaporated oxidizer 210 (liquid oxygen or Lox), as a main propellant. From an area ratio of 5 to 6.3 the expansion nozzle shell 164 is cooled solely by convective coolant 146 used as the nozzle film coolant 128 at a flowrate that can be about 1.1% of the total fluid flowrate to the rocket engine 124. Other convective coolant 146 flowrate percentages as nozzle film coolant 128 are possible. In addition, other quantities of boiling coolant 148 can be evaporated in the pool-boiling heat exchanger 136 as a percentage of total fluid flow to the rocket engine 124.

The fluid flow passages of the pool-boiling cooling system 220 are shown in FIG. 2 as lines connecting the various components and represent flow passages such as pipes, tubes, hoses, or other types of flow passages. The arrows in the figures adjacent to, on, or inside the flow passages indicate the flow direction of the fluid in the flow passages. For instance in FIG. 2 line 114 is the fluid flow passage 114 between the thrust chamber 120 and pool-boiling heat exchanger 136 while the arrow on the flow passage 114 represents the convective coolant 146 flowing in the flow passage 114.

Note that FIG. 2 does not show the main fuel 200 and liquid oxygen 210 inlets and valves to the main propellant injector 140.

### Apparatus of Method

### Example Thrust Chamber

The thrust chamber 120 comprises the rocket engine's 124 combustion chamber 160 and expansion nozzle 180. The example thrust chamber 120 of this disclosure is comprised of a dual-shell structure comprising of an inner shell 104 and outer shell 106 that are made of nickel-plated HY-130 alloy sheet steel. A gap 110 exists between the inner and outer shells 104, 106. The interior wall of the inner shell 104 is optionally spray coated with a 0.010″ thick layer of Inconel that forms the actual hot-wall 122 of this example thrust chamber 120. The convective coolant 146 flowing through the gap 110 between the shells is a 60/40 (by volume) mixture of ethyl alcohol and water with a freezing point of −35 degF. The delivered liftoff and vacuum specific impulses for this example rocket engine 124 are approximately 243 sec and 291 sec respectively.

The combustion chamber film coolant 150 is jet fuel at a flowrate of about 3.6% of the total fluid flowrate to the combustion chamber 160 or about 3.5% of the total fluid flowrate to the rocket engine 124 and is injected onto the hot-wall 122 in a manner as is shown in FIG. 3. The convective coolant 146 that flows through the gap 110 (between the inner and outer shells 104, 106) is chilled as it flows through the pool-boiling heat exchanger 136 to about 40 degF. in order to help prevent destructive bulk boiling in the thrust chamber gap 110 or overheating of the thrust chamber inner shell 104. The convective coolant 146 can be cooled to other temperatures in the pool-boiling heat exchanger 136 as well.

The expansion nozzle shell 164 is exclusively film cooled with convective coolant 146 from the area ratio of 5 to 6.3. This nozzle film coolant 128 is fed into the cooling system by a coolant feed tank 112 (FIG. 2). Exclusively film cooling at least a portion of the expansion nozzle shell 164 ensures that the coolant feed tank 112 is completely empty at rocket engine shutdown. A film coolant is a gas, multi-phase, critical or sub-critical, or liquid fluid that is injected or sprayed on the interior wall 122 (the hot-wall) of any portion of the thrust chamber 120. The film coolant may be a coking film coolant (deposits carbon on the thrust chamber inside wall) or a non-coking fluid depending on preference or technical necessity.

### Apparatus of Method

### Example Pool-Boiling Heat Exchanger

The example heat exchanger that removes the heat from the convective coolant 146 (heat that was absorbed in the thrust chamber 120) is a pool-boiling heat exchanger 136 (FIG. 2) that uses liquid oxygen, Lox, as the boiling coolant 148 to cool the convective coolant 146. What happens in a pool-boiling heat exchanger 136 is that some percentage, about 10% of the total Lox flow rate to the rocket engine 124, is evaporated into gas (Gox) that flows in a gas-tube 132 to the rocket engine 124 as a main propellant. This production of gaseous propellant (Gox) can prevent the two conditions from occurring when the boiling coolant 148 is a cryogenic fluid like Lox or other fluid:

A.) It prevents significant two-phase fluid flow or even slug-flow to the rocket engine 124.

B.) It raises the boiling coolant temperature 148 enough to prevent the freezing of or build up of frost in the convective coolant 146 flowing in the heat exchanger flow passages 152 of the pool boiling heat exchanger 136.

To accomplish this the heat exchanger container 138 is about half filled with boiling coolant 148 (Lox in FIG. 2) that is heated to boiling temperature by convective coolant 146 flowing through the heat exchanger flow passages 152 inside the heat exchanger container 138. The heat exchanger flow passages 152 in FIG. 2 are tubes. After the specified portion of boiling coolant 148 (Lox in FIG. 2) evaporates its vapor (Gox in FIG. 2) exits through an 8″ inside diameter central gas-tube 132 and is ducted to the main propellant injector 140 as part of the overall oxidizer 210 flowrate. The use of a gas for at least a portion of the main rocket engine's main propellant will help stabilize the engine's combustion and improve its combustion efficiency. To maintain the level of the boiling coolant 148 at a specified level in the heat exchanger container 138 the boiling coolant 148 in the heat exchanger container 138 is replenished as helpful through at least one boiling coolant inlet 230.

The example pool-boiling heat exchanger 136 in FIG. 2 is fabricated as a 48 inch ID lithium-aluminum sphere that is approximately half filled with boiling coolant 148, Lox, during operation. In the bottom half of the sphere is a series of ¼ OD×0.016 wall aluminum tubes that form the heat exchanger flow passages 152 in which the heated convective coolant 146 flows. In fact the convective coolant 146 flowrate is evenly divided between 1436 of these tubes 152 that are each 60 inches long and formed to fit inside the pool-boiling heat exchanger 136. These tubes 152 create a so-called ‘birdcage’ in the bottom half of the heat exchanger container 138. Other materials, configurations, numbers, quantities, and dimensions for the components of the pool-boiling heat exchanger 136 are possible.

In the pool-boiling heat exchanger 136 of FIG. 2 one third of the pool-boiling heat exchanger's heat exchanging surface area is tubing while the remaining heat exchanging area are plates 156 (sometimes called fins) attached to the heat exchanger tubes 152. The plates 156 can exchange heat on both plate sides so a 1″×1″ plate 156 would be the equivalent of two square inches of heat exchange area.

A 60/40 mixture (by volume) of ethyl alcohol and water is used as the convective coolant 146 to prevent its freezing in the heat exchanger flow passages 152 when the boiling coolant 148 is a cold or cryogenic fluid.

### Nanofluids as the Convective Coolant

The convective coolant 146 used in this example rocket engine cooling system is a mixture of ethyl alcohol and water. This mixture was chosen in order to combine the low freezing point properties of ethyl alcohol (ethanol) and the heat absorption capabilities of water.

One property of the convective coolant 146 that can always improve the cooling system is greater thermal conductivity. The greater the thermal conductivity of the convective coolant 146, the less conductive coolant flowrate will be required in the cooling system for a given amount of heat removal. Higher thermal conductivity means a smaller, lighter pool-boiling heat exchanger 136, recirculation pump 108, and pump power supply. A higher convective coolant 146 thermal conductivity will give higher heat exchanger flow passage 152 wall temperatures where they need to be warm and colder wall temperatures where the tubes 152 need to be cooler. A higher thermal conductivity convective coolant 146 helps avoid convective coolant freezing or undesirable excessive boiling in either the pool boiling heat exchanger 136 or thrust chamber gap 110.

To significantly increase the thermal conductivity of the convective coolant 146 it is an option to use high conductivity nanofluids as the convective coolant 146. Nanofluids are a liquid coolant with extremely small nano-sized particles suspended in the coolant 146 that can greatly increase the convective coolant's 146 thermal conductivity. Nanofluids utilize minute suspended solid particles such as carbon, nano-carbon tubes, copper, iron, gold, silver or others. The particles are suspended either with electric charges or by chemical additives or other means. Some gains in coolant thermal conductivity by using nanofluids (gains over thermal conductivity of coolants without nano-particles) have been in the range of 5-60% with greater thermal conductivity increases possible.

Nanofluids that provide even a 30% increase in the thermal conductivity of a convective coolant 146 will provide a significant savings in cooling system weight. The specific example cooling system presented in this disclosure (FIG. 2) is not presented as utilizing nanofluids but can be modified to use a nanofluid convective coolant 146 that will provide an improvement in overall cooling system performance.

### Apparatus of Method

### Reduced Specific Impulse Losses with the Use of Film Cooling and Simplifed Nozzle Configuration

The purpose of this part of the invention is to reduce rocket engine performance losses (i.e. Specific Impulse losses or ‘Isp’ losses) due to the use of a simplified expansion nozzle 180 shape or contour or due to film cooling 150, 128 of the rocket engine thrust chamber 120. This reduction in Isp losses is created by causing an increase afterburning of a combustible film coolant in the rocket engine's expansion nozzle 180. This method also allows for the use of simplified or shorter conical or cone- shaped expansion nozzles 180 without reduced specific impulses losses that usually accompany such nozzle shapes or configurations.

FIG. 3 shows an example rocket engine that utilizes this invention to minimize the Isp losses that are incurred due to the use of film cooling. The types of rocket engines that can use this invention include but are not limited to the configuration in FIG. 3. To achieve its purpose of minimizing film cooling Isp losses, this invention utilizes three attributes:

A.) A layer of fuel-rich combustible film cooling fluid (such as jet fuel) flowing along at least a portion of the hot-wall 122 of the thrust chamber 120 (called the film coolant boundary layer 162).

B.) Thrust chamber 120 core combustion gases 158 that are oxidizer-rich (see FIG. 3).

C.) An expansion nozzle 180 that induces turbulence in the film coolant boundary layer 162 (in the expansion nozzle 180).

Core gases 158 are high temperature gases flowing in the thrust chamber 120 that are the result of burning the main propellants but do not include the film coolant boundary layer 162. What happens is that when a combustible film coolant (150 or 128) flows into the expansion nozzle 180, the expansion nozzle 180 is shaped such that it induces turbulence in the film coolant boundary layer 162, and causes increased mixing between the fuel-rich, combustible film coolant boundary layer 162 and the oxidizer-rich core combustion gases 158. This increased mixing results in increased combustion of the fuel-rich, combustible film coolant (150 or 128) in the expansion nozzle 180, a process called ‘afterburning’. This afterburning is caused by the expansion nozzle 180 being shaped such that the gas/fluid flow in the expansion nozzle 180 attempts to separate from the hot-wall 122. This partial separation causes the fuel-rich, film coolant boundary layer 162 to develop eddy currents or other kinds of turbulence 166 (FIG. 3), that in-turn causes increased mixing between the combustible film coolant (150 or 128) and the oxidizer-rich core gases 158. This mixing results in a more complete combustion of the fuel-rich, film coolant boundary layer 162 than would other wise happen without the turbulence/mixing 166. The combustion of the fuel-rich, film coolant boundary layer 162 in the expansion nozzle 180 adds more energy to the gases flowing through the expansion nozzle 180 and increases the expansion nozzle 180's gas expansion efficiency, called the Thrust Coefficient Efficiency or Cf Efficiency in the rocket industry. The increase in Cf Efficiency reduces specific impulse (Isp) losses incurred by the rocket engine by the use of film coolant and thus creates a more efficient and powerful engine (i.e. more thrust) for a given total fluid flowrate to the engine (i.e. in the apparatus described in FIG. 3 of this disclosure the total fluid flowrate is the main propellants plus any film coolant).

By this method the wider the expansion nozzle's 180 expansion angle (called the diverging half-angle 168, FIG. 1) the more turbulence 166 in the film coolant boundary layer 162 will be achieved. This turbulence 166 causes increased mixing/combustion between the oxidizer-rich core gases 158 and the fuel rich film coolant boundary layer 162, thus providing reduced film coolant and conical nozzle Isp losses. This reduction in Isp losses for such a thrust chamber 120 will vary with a change in diverging half-angle 168 until an optimal diverging half-angle 168 is achieved and this optimal value will vary depending on the specific rocket engine characteristics.

An example apparatus demonstrating this method is presented here for a 4500 lbs thrust liquid bipropellant, pressure-fed rocket engine, using liquid oxygen as the main oxidizer 210 and jet fuel and the main fuel 200 and also as the thrust chamber film coolant 150 (see FIG. 3). The amount of jet fuel film coolant flow is 5.3% of the total fluid flow to the engine which in the configuration of FIG. 3 is comprised of the main propellants 200, 210 and the thrust chamber film coolant 150. This engine has a combustion chamber 160 operating pressure of 300 psia and an oxidizer-rich core combustion gas 158 mixture ratio of 2.985 whereas the theoretically optimal mixture ratio for this type of rocket engine is about 2.35. In addition, the expansion nozzle 180 on this engine is a conical expansion nozzle 180 with a diverging half-angle 168 of approximately 27.5 degrees whereas the theoretically optimal diverging half-angle 168 for a conical expansion nozzle 180 is 15 degrees. This engine has three characteristics that should indicate that it would have low Isp performance: it has a non-optimal core gas 158 oxidizer-rich mixture ratio of 2.985, a large amount of film coolant flow of 5.3% of total fluid flow to the rocket engine (about 3% would be more theoretically optimal), and thirdly, a theoretically non-optimal conical expansion nozzle 180 with a diverging half-angle 168 of about 27.5 degrees. With these numbers the expected Isp loss due to the film coolant should be a minimum of 6.5 seconds, while the expansion nozzle 180 Thrust Coefficient Efficiency (i.e. Cf Efficiency) should be about 0.92-0.93 for an expansion nozzle 180 with a 27.5 degree half angle. A conical expansion nozzle 180 with a 15 degree half angle should have a Cf efficiency of about 0.985. In reality, this engine is expected to have a low film coolant Isp loss of 1.3 seconds and a high expansion nozzle 180 Cf Efficiency of 0.9945. (i.e. 99.45%). The reduced film coolant Isp loss and the increased expansion nozzle Cf efficiency are due to increased film coolant afterburning in the expansion nozzle 180 because of the shorter, wider-angled conical expansion nozzle 180 (i.e. much wider than 15 degrees) that creates more turbulence, mixing, and combustion of the fuel-rich film coolant with the oxygen-rich core gases than would be the case with a theoretically optimal 15 degree conical expansion nozzle 180. Usually flight rocket engines have, not conical expansion nozzles 180, but DeLaval or ‘Bell’ expansion nozzles 180. Bell expansion nozzles' 180 are contoured such that the gas flow efficiently attaches itself to the expansion nozzle 180 wall as the hot gases flow out the expansion nozzle 180. Since Bell expansion nozzles 180 are specially contoured they are more expensive and difficult to make than a conical expansion nozzle 180.

What this invention does is allow the designer to use simpler conical nozzles that are almost, just as, or more efficient than Bell expansion nozzles 180. Bell expansion nozzles 180 usually have a theoretical Cf Efficiency of about 0.99 while a 15 degree conical expansion nozzle 180 has a theoretical Cf Efficiency of about 0.985. A 27.5 degree conical expansion nozzle 180 has a theoretical Cf Efficiency of about 0.92-0.93. With the increased afterburning of a combustible film coolant 150 in the expansion nozzle 180 a wider-angle conical expansion nozzle 180 (such as a shorter, conical expansion nozzle 180 with a diverging half-angle 168 of 27.5 degrees) can have an actual Cf Efficiency of about 0.99 or greater. Since a conical expansion nozzle 180 is simpler, easier, and cheaper to make than a Bell expansion nozzle 180 this invention would allow rocket engine designers to effectively utilize conical expansion nozzles 180 with the same efficiency as the more complex and expensive Bell nozzles. In addition, the designers can use conical expansion nozzles 180 with wider diverging half-angles 168 (such as 27.5 degrees) with high Cf Efficiency as opposed to the theoretically optimal conical expansion nozzle 180 with an diverging half-angle of 15 degrees. The wider-angle expansion nozzles 180 will result in a shorter expansion nozzle length for a given nozzle expansion ratio (i.e. sometimes called Area Ratio) than the length of a 15 degree conical expansion nozzle 180. Thus the rocket engine would have a greater overall volume packing efficiency.

### Some Modifications and Variations to the Invention

It is to be understood that modifications and variations of the described embodiment of our invention are possible, in conformity with the foregoing disclosure, within the scope of the presented claims.

In the previous sections, a version of the method and apparatus are described in sufficient detail to enable those skilled in the art to derive or produce other versions of this invention, and it is to be understood that other embodiments may be utilized and that logical, mechanical, electrical and other changes may be made without departing from the scope of this patent. The above examples and detailed descriptions are, therefore, not to be taken in a limiting sense.

Some of the modifications and variations to the invention that are possible include but are not limited to:

The use of different materials; production processes; fluids; film coolants 150, 128; boiling coolants 148; convective coolants 146; propellants; propellant mixture ratios; coolant composition; any types of percentages; fluid flowrates; fluid flowrates as a percentage of total fluid flow to the rocket engine 124; component arrangements; numbers of components; types of rocket engines; rocket engine thrust; expansion nozzle 180 area ratio; expansion nozzle type; types of thrust chambers 120; types of main propellant injectors 140; tube, pipe, or flow passage sizes; surface areas; cross-section areas and shapes; hardware arrangements, shapes, sizes, spacing; surface areas; volumes; values; material coatings or plating; heat exchanging area or volume; fluid flow directions; tank or container sizes; fluid temperatures; dimensions; hardware temperatures; component attach points; % of convective coolant 146 evaporated; fluid phases; combustion chamber 160 operating pressures; other component or fluid pressures; flowrate of any film coolant, convective coolant 146, or propellant; fluid levels; fluid velocities; rocket engine 124 specific impulses; valve types, number, or arrangements; or other variations;

This invention can be used with any type of thrust chamber 120 design or configuration where helpful including but not limited to conventional regenerative-cooled rocket thrust chambers at least partially fabricated with multiple coolant tubes or coolant channels, or thrust chambers at least partially incorporating spray cooling or any combination of these or other cooling techniques including ablative, radiation, heat sink, transpiration and other types of cooling.

Other than producing gas that can be a propellant for the rocket engine, a pool-boiling heat exchanger 136 can be used to produce gas or a other phase of fluid for pressurizing propellant tanks, coolant tanks, pressurant tanks, other tanks or containers, or for driving pumps or turbines, or for other uses.

One alternative to having a stand-alone pool-boiling heat exchanger 136, all or part of the heat exchanging surfaces (i.e. heat exchanger tubes 152 and plates 156 in the example pool-boiling heat exchanger 136 of this disclosure) can be located inside a propellant tank, coolant tank, or other container to evaporate propellant, coolant, or other fluid into gas, the gas being burned in the rocket engine 124 as propellant, or used as a rocket engine coolant, or used as a pressurizing gas for any tank or container, or used for driving a power supply or turbine, or used for any other purpose requiring gas, or used for any combination of these uses. Or, a portion of the heat exchanger flow passages 152 can be inside a propellant tank, coolant tank, or other container and a portion of the heat exchanger flow passages 152 can be installed in a separate pool-boiling heat exchanger 136. The convective coolant 146 can be used to warm any kind of fluid be it a liquid fluid, multi-phase fluid, critical or sub-critical fluid, gas or other fluid such as in heating a rocket vehicle's pressurizing gas.

In another variation the pool-boiling cooling system 220 does not expend the convective coolant 146 as a nozzle film coolant 128 nor for any other purpose, but the convective coolant 146 flows through the coolant loop 116 in a closed-loop manner in which no convective coolant 146 is expended so that the coolant feed tank 112 utilized in the cooling system 220 can be eliminated as helpful.

In yet another variation of the pool-boiling cooling system 220, instead of expending at least a portion of the convective coolant 146 flowrate as a nozzle film coolant 128, at least a portion of the convective coolant 146 can be expended by dumping it overboard from the pool-boiling cooling system 220. The dumping overboard of the convective coolant 146 from the pool-boiling cooling system 220 can be accomplished by active or passive means and can be done either on a continuous or intermittent basis.

In another variation of the invention the convective coolant 146 can be used to cool not only at least a portion of the thrust chamber 120 but also at least a portion of the main propellant injector 140.

Another variation of the invention is that the rocket engine can be any type of rocket or jet engine, rocket thruster, or rocket or jet propulsion device. This includes pressure-fed rocket engines or rocket engines that have any of their fluids fed to them by pumps that can be driven by any means. This includes turbopump-fed rocket engines that have their propellants fed to them by turbine driven pumps. In addition, the types of rockets and rocket engines that can use this invention, method, or apparatuses include solid propellant rocket, hybrid propellant rockets, and liquid propellant rockets utilizing any number or type of propellants or coolants. With solid propellant rockets the main propellants are in a solid form so that any coolants would have to be carried in their own tanks for there is no liquid propellant to use as a coolant. In hybrid propellant rockets at least one main propellant is a liquid, supercritical fluid, or gas and at least one propellant is a solid. If the non-solid propellant of a hybrid rocket device is appropriate as a coolant than it can be used as a coolant consistent with this disclosure. In addition, a hybrid rocket can carry additional coolants in separate containers or tanks. In addition to pressurized tanks and pumps bringing fluids to the rocket engine 124, static and acceleration head pressure can also be used to bring propellants to the rocket engine as helpful.

Liquid propellant rocket systems that use this invention can utilize any number of propellants including monopropellant, bi-propellant, tri-propellant and other types of liquid rocket engines or liquid rocket systems. This invention can be used with a rocket engine 124 utilizing any type of main propellant injector 140 or thrust chamber 120 shape or contour where preferred or helpful. Jet engines or gas generators combusting any type of propellants can use this invention or any of its variations where helpful. A gas generator is defined in this disclosure as a device that has the primary purpose of generating gas, vapor, super-critical fluid, or any combination of these.

In another variation of the invention the pool-boiling heat exchanger 136 can be of any shape or size or be filled to any level or any volume with boiling coolant 148 where helpful or preferred. In addition the heat exchanger flow passages 152 do not have to be tubes with plates 156 or tubes at all but any type, shape, material size, configuration, or number of convective coolant 146 flow passages that can transfer heat as helpful or preferred and can take up any percentage of the internal volume of the heat exchanger container 138 as helpful or preferred.

In another variation of the invention film coolant can be used to at least partially cool any portion or percentage of the thrust chamber 120 or main propellant injector 140 or rocket engine 124, jet engine, or gas generator that is helpful. Likewise any combination of thrust chamber film coolant 150 or nozzle film coolant 128 can be used either in combination with each other or one without the other or no film coolant at all can be used. In addition, any film coolant can be injected anywhere in the thrust chamber 120 or rocket engine 124 and in any flowrate or at any percentage relative to the total fluid flowrate to the rocket engine 124 or thrust chamber 120 as is helpful. Any film coolant can be a fluid of any phase or state as helpful including but not limited to a liquid, gas, vapor, multi-phase fluid, critical fluid, sub-critical fluid, any combination of these or other states. In addition, the film coolant injection points can be located anywhere on the rocket engine 124 or thrust chamber 120 where helpful or preferred. FIG. 2 shows the nozzle film coolant 128 being injected into the expansion nozzle 180 from an optional film coolant manifold 216. A film coolant manifold 216 can be shaped or oriented or sized or used with any film coolant as helpful or preferred. Any film coolant can be a rocket engine 124 main propellant or non-main-propellant as helpful or preferred. Any variations of this invention that are valid for rocket engines are also valid for jet engines and gas generators.

In another variation of this invention the vaporized boiling coolant 148, called the evaporated coolant 134, which is Gox in the example cooling system of FIG. 2 in this disclosure, that is flowing out of the pool-boiling heat exchanger 136 can be comprised entirely of gas, or a multiphase fluid, or as a mixture of gas and liquid, or a critical or sub-critical fluid. In addition, all of the evaporated coolant 134 can flow to the main propellant injector 140 or a portion of the evaporated coolant 134 can flow to the main propellant injector 140, or a portion of the evaporated coolant 134 can flow to another component for another purpose such as pressurizing a tank or container or driving a turbine.

In another variation to this invention the convective coolant 146 can flow into the gap 110 and out of the gap 110 at any location of the thrust chamber 120 or can flow in the gap 110 in any direction such as from the expansion nozzle 180 towards the main propellant injector 140, or opposite to this direction, or in any other direction that is helpful including flowing in a spiral pattern around the thrust chamber 120.

Existing technology components can be used with this invention where helpful such as using any types of valves in any location or in any way that is helpful or applying stiffening or strengthening members where helpful such as putting stiffening or fluid deflection ribs in the gap 110 or on the inner or outer shells 104, 106 as helpful, or putting any kind of spacers in the gap 110 when helpful. The valves and other components shown in FIG. 2 and other figures are optional and can be used, arranged, configured, or not used in any way that is helpful. This includes but is not limited to the coolant check valve 236, the nozzle coolant valve 126, the boiling coolant valve 228, the boiling coolant inlet 230 to the pool-boiling heat exchanger 136, the convective coolant manifold 137, the nozzle coolant manifold 216, the thrust chamber film coolant manifold 186, the nozzle coolant inlet 238, and the recirculation pump 108. The recirculation pump 108 can be any type of pump or driven by any means that is helpful. Any number of pumps can be used or located anywhere in the cooling system where helpful. The recirculation pump 108 can be eliminated if other means of circulating the convective coolant 146 are adequate and available such as the use of surface tension as in a heat-pipe device.

The invention of this disclosure can be controlled either actively or passively in any way helpful such as with passive flow control orifices or valves or with active electronic sensors or computer control devices or controlled devices such as controlled valves.

In he pool-boiling heat exchanger 136 of FIG. 2 the gas-tube 132 is shown inside of and coming out the bottom of the heat exchanger container 138 (as seen in FIG. 2). This is an optional configuration for the gas-tube 132. In another variation to this invention a gas-tube 132 or any number, shape, or size of gas-tubes 132 can come out the top of the heat exchanger container 138 or out any other location on the heat exchanger container 138 and be routed exterior to the heat exchanger container 138 in any configuration where helpful. Likewise, the heat exchanger container 138 can have in its interior or exterior any ribs, plates, baffles, or other members that are helpful in stiffening, controlling heat transfer, controlling sloshing of the fluid inside the pool-boiling heat exchanger 136, or for other purposes.

FIG. 2 shows a film coolant, the nozzle film coolant 128, being injected along the hot-wall 122 of the expansion nozzle 180 in order to cool the expansion nozzle structure. FIG. 3 shows a thrust chamber film coolant 150 injected along the hot-wall 122 of the combustion chamber 160 just below the main propellant injector 140. Any rocket engine 124 can use either of these film coolant injection configurations or in combination with each other or film coolant can be injected anywhere or at as many places on the thrust chamber 120 where helpful. Likewise, the film coolant can be any type of fluid where helpful such as using convective coolant 146 as film coolant or using a main propellant as film coolant. For instance, FIG. 2 only shows a nozzle film coolant 128 being used but in addition to this a thrust chamber film coolant 150 can be injected on the hot-wall 122 in a configuration as shown in FIG. 3. A hydrocarbon fuel such as jet fuel or rocket fuel would be helpful to the rocket engine 124 of FIG. 2 because a hydrocarbon fuel deposits carbon on the hot-wall 122 which helps insulate the thrust chamber structure (inner, outer, and nozzle shells 104, 106, 164) from the heating effects of the core combustion gases 158 and helps the convective coolant 146 run cooler for a given flowrate of convective coolant 146. Any film coolant can be injected into the thrust chamber 120 in any injection manner where helpful such as from a separate film coolant manifold, or from the main propellant injector 140, or can be injected perpendicular, parallel, or at an angle to the flow of the core combustion gases 158, or can be injected as a swirl or vortex spiraling around the hot-wall 122 of the thrust chamber 120 or can be injected by other any other means that is helpful. Film coolant is usually, but not always, injected onto the hot-wall 122 through a series of holes 240 (FIG. 3), slots, or gaps located around the circumference of the thrust chamber hot-wall 122 or main propellant injector 140.

The fabrication of one or more steps 244 or adding surface roughness to the hot-wall 122 of the expansion nozzle 180 (FIG. 4) will increase mixing turbulence 166 in the expansion nozzle 180. It is an option that one or more steps can be used in any type of expansion nozzle where helpful. Film coolant can be injected any where in the thrust chamber 120 that is helpful or preferred, so the film coolant 128 injection location shown in FIG. 4 is optional. As seen in FIG. 4 the steps are a discontinuity in the hot-wall surface of the expansion nozzle or thrust chamber 120 and can be of any configuration, dimension, number, or orientation, or can partially or entirely wrap around the expansion nozzle 180 or thrust chamber 120.

The inner shell 104 and outer shell 106 can be connected to each other by any methods or the gap 110 can be of any dimension or dimensions that is helpful.

FIG. 3 shows a rocket engine assembly 246 that has a fuel-rich film coolant boundary layer 162 with oxidizer-rich core gases 158. One variation to this is to have fuel-rich core gases 158 used with an oxidizer-rich film coolant boundary layer 162.

We claim:

1. A method comprising of a pool-boiling cooling system 220 whereas a convective coolant 146 flows through at least a portion of a thrust chamber 120 of a rocket engine, also called a combustion device, to cool at least a portion of the thrust chamber 120, and whereas, after cooling at least a portion of the thrust chamber 120 the convective coolant 146 is flowed through a pool-boiling heat exchanger 136 where the convective coolant 146 is cooled and then the convective coolant 146 is flowed back to the thrust chamber 120 to flow through at least a portion of the thrust chamber 120 and to cool at least a portion of the thrust chamber 120; and whereas this process is repeated at least once in a coolant loop 116.

2. The method of claim 1 whereas a convective coolant 146 flows through a gap 110 in at least a portion of a thrust chamber 120 that is between an inner shell 104 and an outer shell 106.

3. The method of claim 1 whereas the pool-boiling heat exchanger 136 comprises of at least one heat exchanger container 138, at least one heat exchanger flow passage 152, at least one gas-tube 132, and is partially filled with a boiling coolant 148.

4. The method of claim 1, whereas at least a portion of a boiling coolant 148 that is in a pool-boiling heat exchanger 136 is heated and evaporated by a convective coolant 146 flowing through at least one heat exchanger flow passage 152 inside a pool-boiling heat exchanger 136.

5. The method of claim 1, whereas at least a portion of a boiling coolant 148 that is evaporated in a pool-boiling heat exchanger 136 is flowed through a gas-tube 132 to a rocket engine 124 and is burned in the rocket engine 124 as main propellant.

6. The method of claim 1 whereas a heat exchanger container 138 of a pool-boiling heat exchanger 136 is a propellant tank.

7. The method of claim 1 whereas the heat exchanger container 138 of a pool-boiling heat exchanger 136 is a propellant tank and a boiling coolant 148 in a pool-boiling heat exchanger 136 is a propellant and at least a portion of the evaporated boiling coolant 148 is used to pressurize a propellant tank.

8. The method of claim 1, whereas at least a portion of the convective coolant 146 flowrate to the thrust chamber 120 is injected onto the hot-wall 122 of at least a portion of the expansion nozzle 180 to cool at least a portion of the expansion nozzle 180.

9. The method of claim 1 whereas at least one coolant feed tank 112 is connected to the coolant loop 116 in order to replenish convective coolant 146 that is expended from the coolant loop 116.

10. The method of claim 1 whereas at least a portion of the thrust chamber is at least partially cooled with thrust chamber film coolant 150.

11. The method of claim 1 whereas a convective coolant 146 cools at least a portion of a main propellant injector 140.

12. A pool-boiling cooling system 220 apparatus that comprises of a thrust chamber 120 the structure of which is comprised of an inner shell 104 and an outer shell 106 with a gap 110 in between these two shells; and a nozzle shell 164; and
at least one pool-boiling heat exchanger 136 that is comprised of at least one heat exchanger container 138, at least one heat exchanger flow passage 152; and at least one gas-tube 132; and
a quantity of convective coolant 146 that flows through the gap 110 in the thrust chamber 120 and thereby cools at least a portion of the thrust chamber 120 and then the quantity of convective coolant 146 flows out of the gap 110; and
then the quantity of convective coolant 146 flows into at least one heat exchanger flow passage 152 that is part of a pool-boiling heat exchanger 136 and heats and at least partially evaporates boiling coolant 148 that is in a pool-boiling heat exchanger 136, and boiling coolant 148 in a heat exchanger container 138 that has been at least partially evaporated by the convective coolant 146 flowing in the heat exchanger flow passages 152 then flows through at least one gas-tube 132 to the rocket engine 124 to be burned in the thrust chamber 120 as a main propellant; and
then a quantity of convective coolant 146 flows into at least one recirculation pump 108 that pumps convective coolant 146 back to the thrust chamber 120 where convective coolant 146 flows into the thrust chamber gap 110 between the inner and outer shells 104, 106 cooling at least a portion of the thrust chamber 120; and
this flow of the quantity of convective coolant 146 through its cooling circuit, called the coolant loop 116, is repeated at least through one cycle; and
a portion of the convective coolant 146 flowrate through the pool-boiling cooling system 220 flows to the nozzle shell 164 where it is injected along the expansion nozzle 180 hot-wall 122 as a nozzle film coolant 128 that cools at least at least a portion expansion nozzle 180, and
at least one coolant feed tank 112 adds convective coolant 146 to coolant loop 116 as helpful.

13. The method of claim 1 whereas the thrust chamber is a conventional fluid-cooled rocket thrust chamber.

14. The method of claim 1 whereas the combustion device is a jet engine.

15. The method of claim 1 whereas the combustion device is a gas generator.

16. The method of claim 1 whereas the evaporated coolant 134 generated by the pool-boiling heat exchanger 136 is a multi-phase fluid.

17. The method of claim 1 whereas the convective coolant 146 is a nanofluid.

18. A method comprising of a rocket engine with a rocket thrust chamber 120 that has within it oxidizer-rich core combustion gases 158 and the rocket thrust chamber 120 is at least partially cooled with a film coolant that is a fuel.

19. The method of claim 19 whereas the rocket engine has a conical shaped expansion nozzle 180 and whereas turbulence 166 in the conical expansion nozzle 180 increases afterburning of the fuel film coolant in the expansion nozzle 180 and increases rocket specific impulse performance.

20. The method of claim 19 whereas the rocket thrust chamber 120 has a parabolic shaped or bell expansion nozzle 180 and whereas turbulence 166 in the bell expansion nozzle 180 increases afterburning of the fuel film coolant in the expansion nozzle 180 and increases rocket specific impulse performance.

21. The method of claim 19 incorporated into an apparatus that is a rocket engine that has a thrust chamber 120 with a conical expansion nozzle 180 with a diverging half-angle 168 greater than 15 degrees, and
operates with core combustion gases 158 that are oxidizer-rich, and the thrust chamber 120 is at least partially film cooled with a film coolant that is combustible with the oxidizer-rich core combustion gases 158, and
the specific impulse losses are reduced.

22. The method of claim 19 whereas at least one step 244 is fabricated into the hot-wall 122 of the expansion nozzle 180.
